(19) United States
(12) Patent Application Publication
(10) Pub. No.: US 2005/0246422 A1
(43) Pub. Date: Nov. 3, 2005

(54) System and method for interactive internet co-browsing

(76) Inventor: David Bruce Laning, Sacramento, CA (US)

Correspondence Address: DAVID BRUCE LANING;SUITE 120 # 150, 4660 NATOMAS BLVD, SACRAMENTO, CA, 95835-2225, US

(21) Appl. No.: 11/106,964

(22) Filed: Apr. 14, 2005

Related U.S. Application Data
(60) Provisional application No. 60/562,042, filed on Apr. 14, 2004.

(51) Int. Cl. G06F 15/16

(52) U.S. Cl. 709/205; 709/204

(57) ABSTRACT

A system and method for interactive internet co-browsing comprising an internet web browser (20), an enhancement to that internet web browser in the form of a web browser toolbar (10), web browser pages (90) and web server (72) all connected by an internet connection. The enhancement to the web browser can be made a core feature of a web browser. The co-browsing system provides a way for an individual or multiple individuals to lead an internet web co-browsing session while an individual or multiple individuals follow the internet web co-browsing session. Co-browsing can be done with a low data rate connection since only URL data obtained from the browser document object model is transmitted between leaders and followers. An alternative embodiment makes it possible to co-browse using a variant of the web browser toolbar that writes and reads web browser URL information to and from an instant messenger chat client.

### CROSS REFERENCE TO RELATED APPLICATIONS

This application is based on provisional application Ser. No. 60/562,042, filed on Apr. 14, 2004.

### STATEMENT REGARDING FEDERALLY SPONSORED RESEARCH OR DEVELOPMENT

Not Applicable

### DESCRIPTION OF ATTACHED APPENDIX

Not Applicable

### TECHNICAL FIELD

This invention relates generally to the field of internet web browsers and more specifically to a system and method for interactive internet co-browsing using an enhanced internet web browser and web browser pages.

### BACKGROUND OF THE INVENTION

The invention provides a way for an individual or multiple individuals to lead an internet web co-browsing session while an individual or multiple individuals follow the internet web co-browsing session. The invention accomplishes the co-browsing through the use of an internet web browser, an enhancement to that internet web browser in the form of a browser toolbar, web browser pages and web server all connected by an internet connection. Co-browsing is the act of more than one individual simultaneously browsing the same web pages or web content while those individuals are using applications that can view the co-browsing on different computers. While co-browsing typically involves displaying the same entire web page or web content to the co-browsing followers, it is also possible to have the co-browsing followers see a specific subset of the entire page such as photos, hyperlinks or any other page objects that are present in the page browsed to by the co-browsing leader or leaders. Furthermore, co-browsing also includes the co-presentation of any other content that is accessible via a Uniform Resource Locator (URL) such as an audio file, video file, or and other content available from a web server.

### BACKGROUND OF THE INVENTION—PRIOR ART

In prior art, co-browsing is accomplished only if both the leader or leaders and follower or followers install and run a special full application on their respective computers. In one approach the special application contains within it an embedded internet web browser that works in conjunction with the special application. In another approach, a special application on the leader's computer replicates the viewed content. in some manner and sends the information to another application installed on the follower's computer. In the present invention, no separate application needs to be installed on either the leader's or follower's computer. Rather, a small embeddable application extension in the form of a web browser toolbar is installed into the leader's web browser to enhance the capabilities of the web browser so that the leader's browser transmits to a state web server all of the information about the currently-displayed web page within the leader's browser such as it's page location with any associated query strings and some or all of the page's objects information like photos, hyperlinks, etc. Followers achieve co-browsing with the leaders by either going to a special web page that periodically gets the page information from the state web server and displays the co-browsed page or by installing a small embeddable application in the form of a web browser toolbar which periodically gets the page information from the state web server and displays the co-browsed page within the follower's web browser.

Another disadvantage of prior art is that typically co-browsing could only be effectively accomplished if all leaders and followers had a broadband internet connection with a data connection rate of 56 kilo-baud or faster.

Another disadvantage of prior art is that the page replication approach to co-browsing would violate copyright laws because copyrighted web pages would be replicated for all the followers to see without first obtaining replication rights from the copyright holder.

Another disadvantage of prior art is that the page replication approach would make it possible for more than one person to see the content of a website that required a login username and password without individually authenticating each of the followers in the co-browsing session. From the perspective of the web site owner this could mean lost revenue and unauthorized viewing of restricted web site material.

Another disadvantage of prior art is that for the page replication approach to work all followers would need to have installed the full co-browse application. This is a severe disadvantage in secure computing environments or locations where installation of applications is not allowed.

Another disadvantage of prior art is that with the page replication technique only one leader can lead a co-browsing session at any given time. This means that an interactive panel discussion using co-browsing techniques is not possible.

Another disadvantage of prior art is that with the page replication technique the number of followers that can co-browse along with the leader is quickly restricted because of the amount of page data that needs to be replicated and sent out to the followers by the replication server can be very large.

### BACKGROUND OF THE INVENTION—OBJECTS AND ADVANTAGES

The primary object of the invention is to provide a system and a method for an individual or multiple individuals to lead an internet web co-browsing session while an individual or multiple individuals follow the internet web co-browsing session.

Another object of the invention is to provide a system and a method for co-browsing that only comprises an internet web browser, an enhancement to that internet web browser in the form of a browser toolbar, web browser pages and web server all connected by an internet connection.

Another object of the invention is to provide a system and a method for co-browsing that only comprises an internet web browser, an enhancement to that internet web browser in the form of a browser toolbar, instant messaging chat client and an instant messaging web server all connected by an internet connection.

Advantages: There are several advantages of the invention over alternative methods for co-browsing:

One advantage is that the leaders need only install a small embeddable application in the form of a web browser toolbar that works directly with the leader's web browser.

Another advantage is that the manufacturer of the web browser can choose to embed the small application enhancement directly into the internals of the web browser and thereby make co-browsing a feature of the browser.

Another advantage is that the followers have two options to choose from in order to be able to co-browse along with the leaders. Followers can either go to a special web page that periodically gets the page information from the state web server and displays the co-browsed page or they can install and run a small embedded application in the form of a web browser toolbar which periodically gets the page information from the state web server and displays the co-browsed page within the follower's web browser. Not mandating that co-browse followers download and install an application is a major advantage of this invention from a convenience perspective. •Another; presentation to the followers. * Another advantage is that if the small embedded application in the form of a toolbar has both the leader and follower functional capabilities then any individual in the co-browsing session can act as either a leader or a follower. This means that the toolbar can act as an instant messenger of co-browsed pages to all of the participants at the same time.

Another advantage of this invention is that it can use the hypertext transfer protocol (HTTP) or the secure hypertext transfer protocol (HTTPS) to send state information to and get state information from the web state server. This means that the standard web browsing ports are the only ones that need to be open on the network to achieve co-browsing.

Another advantage is that since only URL information is passed from the leaders to the followers via the web state server, the required data rates for co-browsing by the leaders and followers can be very low compared to prior art approaches. This makes it possible to do co-browsing with as little as a 14.4 kilo-baud modem. Lower speeds are also practically possible depending on the size of the web pages being co-browsed

Another advantage is that since only URL information is passed to the followers from the state web server, the computational and data transfer load imposed on the web state server is very low compared to other prior art approaches and therefore orders of magnitude more followers can be part of a co-browsing session.

Another advantage is that since only URL data is passed to the state web server by the leader's web browser toolbar application, the leader's or the follower's co-browse application can be configured to display only relevant parts of the co-browsed web file such as only photos, hyperlinks, audio files, etc. or any combination thereof.

Another advantage is that the followers each get and open up their own respective web page. This means that if the leaders browse to a web page that contains a login prompt, each follower will be forced to individually login to that page. This enforces security on each individual follower and forces them to be authenticated individually.

Another advantage is that since only URLs are passed from the leaders to the web state server and then to the follower's browser no copyright laws are violated. This is because the web pages are not replicated and therefore there is no unauthorized replication and redistribution of web pages occurring.

Another advantage is that the embedded browser toolbar bypasses the browser security restrictions. These restrictions prohibit script languages such as Javascript from programmatically extracting web page information such as URLs and query strings from objects inside the web page associated with the document object model when the web page viewed within the browser is from a web server different than the web page that contains the Javascript performing the programmatic extraction. When the Windows application code is performing the programmatic extraction by running from within the browser via the toolbar of this patent application any and all of the web page information can be extracted without restriction.

Another advantage is that this system works with a web page or any other content that is accessible via a URL that is located on a local disk as long as the URL of the file on the local disk is located on all of the follower's respective computers. For example, if a data CD with a particular data content and directory structure is loaded into the computer of every leader and follower and the disk drive letter for the CD was the same for all participants then the URL passed from the leaders to the followers can be that of a local file location with a file:///URL and, the system will properly co-browse all participants.

Another advantage is that the low-data-rate approach used in this system makes it possible to co-browse over low-data-rate connections including low-data-rate wireless connections such as those used in cell phones and wireless personal digital assistants.

Other objects and advantages of the present invention will become apparent from the following descriptions, taken in connection with the accompanying drawings, wherein, by way of illustration and example, an embodiment of the present invention is disclosed.

### SUMMARY OF THE PRESENT INVENTION

In accordance with a preferred embodiment of the invention, there is disclosed a system and method for interactive internet co-browsing comprising an internet web browser, an enhancement to that web browser in the form of a browser toolbar, web browser pages and web server all connected by an internet connection.

### DRAWINGS—FIGURES

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a screen display of the invention illustrating the leader browser with the leader toolbar embedded application installed into the internet web browser

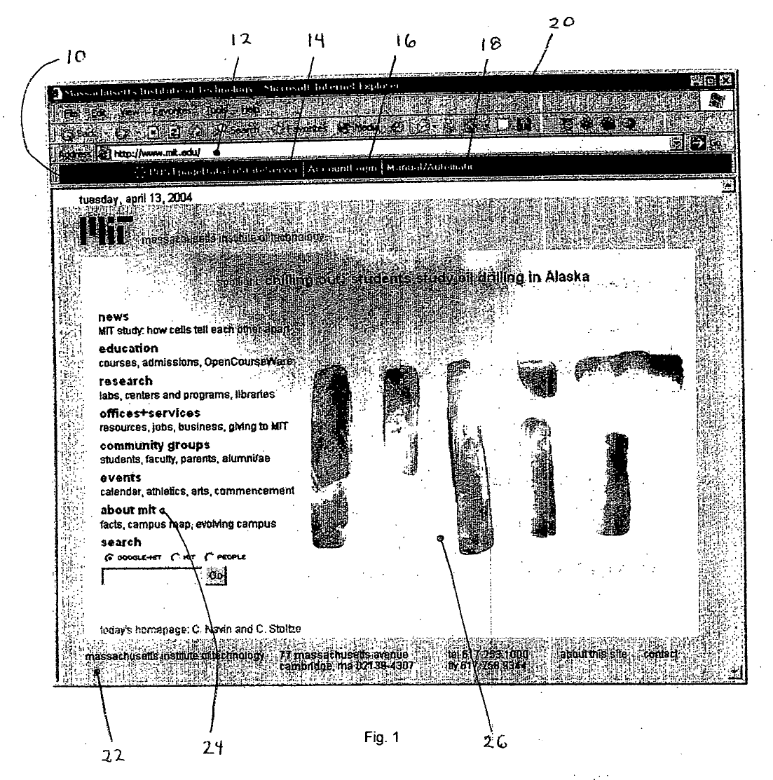

FIG. 2 is a screen display of the invention illustrating the follower browser with the follower toolbar embedded application installed into the internet web browse that periodically gets leader page URL information from the web state server and displays co-browsed data to the follower

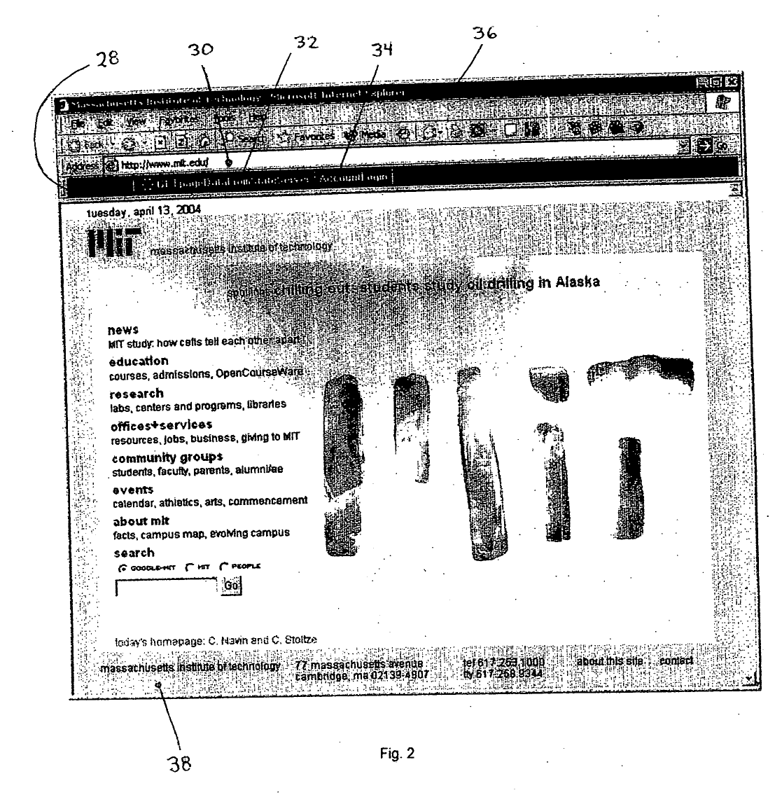

FIG. 3 is a screen display of the invention illustrating the follower browser with a special two-frame web page that periodically gets leader page URL information from the web state server and displays co-browsed data to the follower

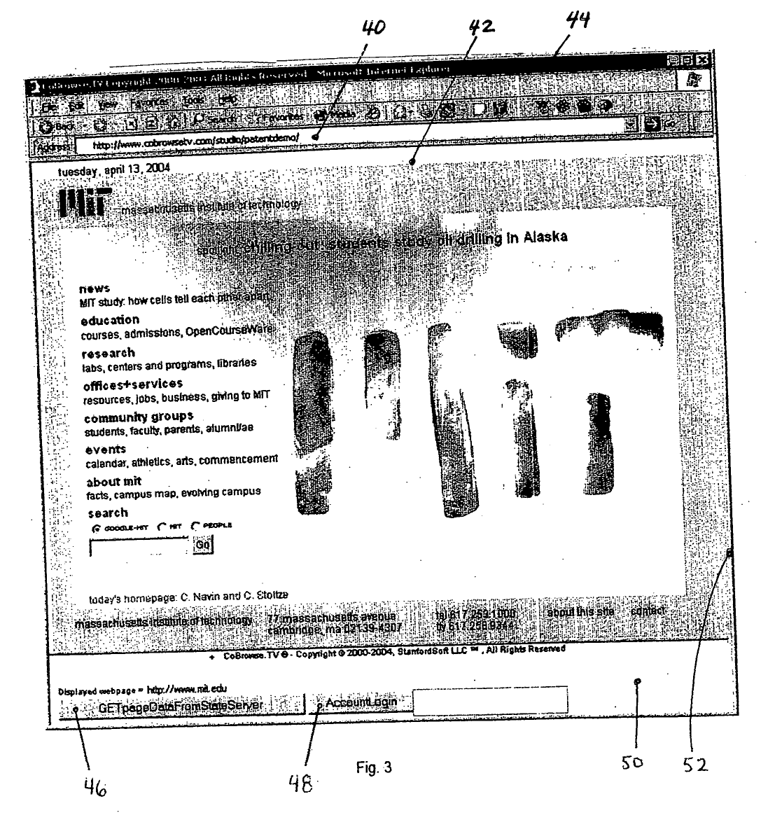

FIG. 4 is a block diagram of the data processing system representing the network system architecture diagram and illustrating the interaction of the network system components.

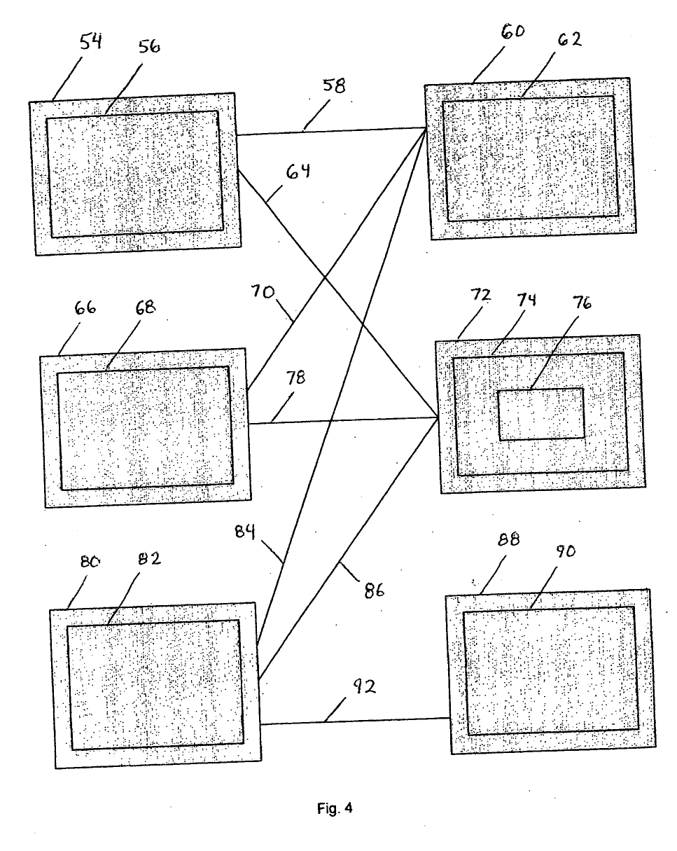

FIG. 5 is a block diagram of the data processing system representing the leader browser-toolbar internal system architecture and illustrating the interaction of the leader browser-toolbar system components.

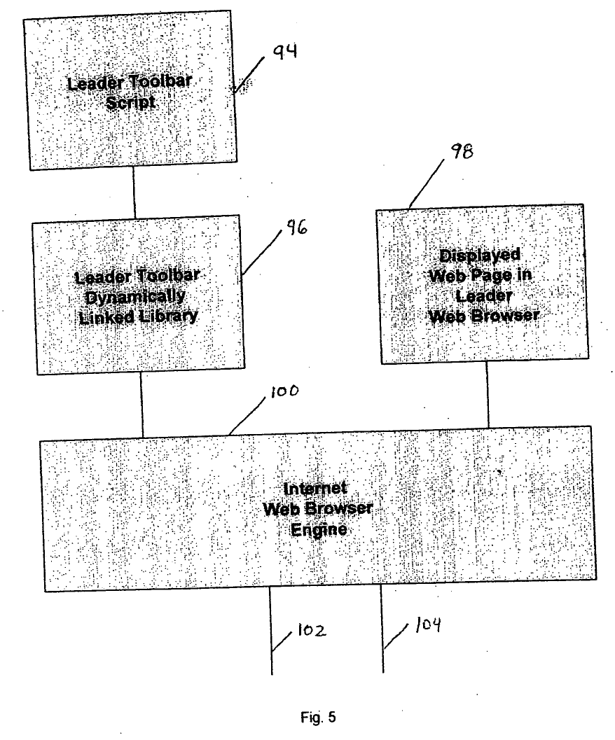

FIG. 6 is a block diagram of the data processing system representing the follower browser-toolbar internal system architecture and illustrating the interaction of the follower browser-toolbar system components.

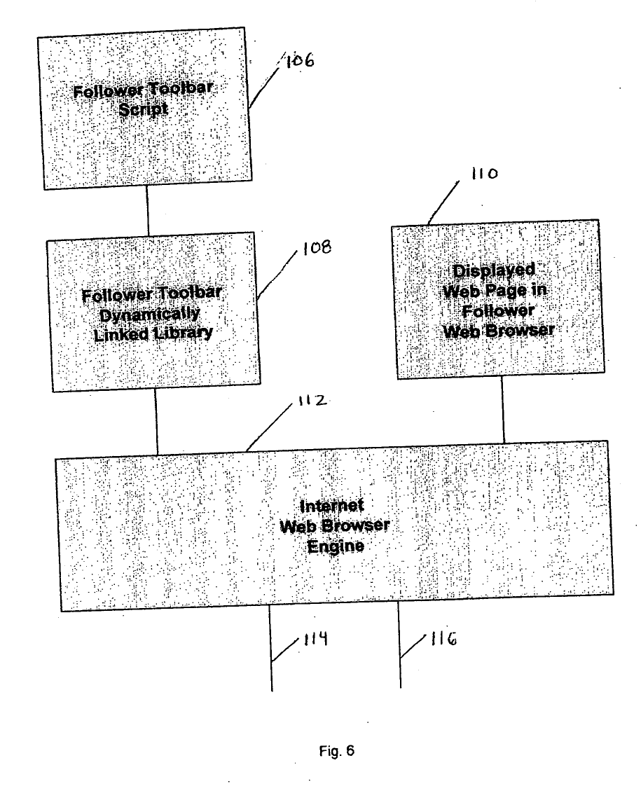

FIG. 7 is a block diagram of the data processing system representing the follower special two-frame web page internal system architecture and illustrating the interaction of the follower special two-frame web page internal system components.

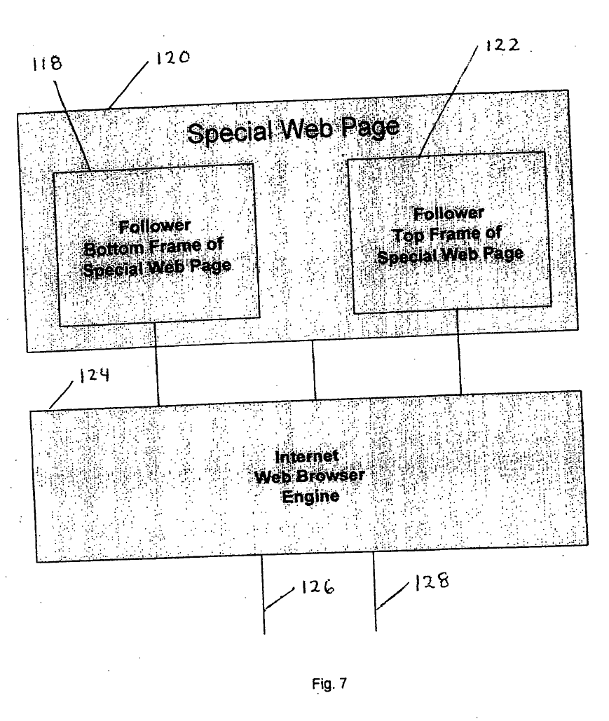

### DRAWINGS—REFERENCE NUMERALS

10—leader toolbar enhancement to the internet web browser of the leader
12—address bar of the leader's browser to enter in the URL address the leader wants to browse to
14—toolbar push button that obtains the web page URL and query string information from the objects inside the web page displayed in the browser and posts the URL and query string information to the web state server
16—toolbar push button that opens up a window for the leader to select and log into the account where the leader's web state information is to be stored on the web state server for use by the follower's web browser
18—manual/automatic button on the leader's web browser toolbar that controls whether or not the leader must manually push the POSTpageDataToStateServer button to post the URL information to the web state server or if the leader toolbar code automatically pushes the POSTpageDataToStateServer button on a periodic basis
20—leader's internet web page browser
22—web page displayed by the leader's web browser that the leaders will want the followers to co-browse to
24—web page hyperlink object within the leader's web browser that is an example of some of the objects contained within a web page that are accessible via the document object model of the browser
26—web page image object within the leader's web browser that is an example of some of the objects contained within a web page that are accessible via the document object model of the browser
28—follower toolbar enhancement to the internet web browser of the follower
30—address bar which displays the URL of the web page displayed in the follower's web browser window as co-browsed to by the leader
32—toolbar push button in the follower's toolbar that initiates the follower's co-browse session and gets the leader's URL information from the web state server and updates. the follower's browser on a periodic basis to match the web page URL of the leader
34—toolbar push button that opens up a window for the follower to select and log into the account where the leader's web state information is to be obtained from the web state server for use by the follower's web browser toolbar and subsequently displayed by the follower's web browser
36—follower's internet web page browser
38—web page displayed by the follower's web browser that the leader has directed the followers to co-browse to via the use of the co-browse system
40—address bar of the follower's browser to enter in the URL address of the special web page the followers needs to go to so as to see the web page co-browse session of the leaders
42—top frame of the special web page that updates to the web page that the leader has directed the followers to co-browse to
44—follower's internet web page browser
46—push button in the lower frame of the follower's special web page that gets the URL information from the state web server and updates the upper frame URL to match that of the leader
48—account login button inside the lower frame web page that opens up a window for the follower to select and log into the account where the leader's web page URL state information is to be obtained from the web state server for use by the follower's web browser toolbar and subsequently displayed by the follower web browser in the top frame
50—bottom frame of the special web page with code inside of it that gets the leader's URL information from the web state server and updates the top frame of the follower's special web page to go to the URL co-browsed by the leader.
52—special web page that contains two frame pages that enable co-browsing by the follower without the need to download a separate application nor install a small embedded follower toolbar application
54—leader's computer within which is the web browser with the embedded leader toolbar
56—leader internet web browser that uses the toolbar
58—network connection between the leader web browser and the web page content server
60—web content server that holds the web pages displayed by the web browser to the leaders and followers
62—web pages and web content displayed or presented by the web browser to the leaders and followers
64—network connection between the leader's web browser and the web state server
66—follower's computer within which is the web browser with the embedded follower toolbar
68—follower internet web browser that uses the toolbar
70—network connection between the follower web browser and the web page content server
72—web state server which saves the URL and other web page information posted to it by the leader
74—account data area on the web state server where the leader's web state information is stored on the web state server for use by the follower's web browser
76—web state information on the web state server where the leader's web state information is stored for use by the follower's web browser. In this implementation the data is stored in a structured Extensible Markup Language (XML) file but in an alternative implementation it could have been stored in memory or on a database
78—network connection between the follower's web browser and the web state server
80—follower's computer within which is the web browser which is using the special two-frame web page
82—follower internet web browser that uses and displays the special two-frame web page
84—network connection between the follower's special web page in the browser and the web page content server
86—network connection between the follower's special web page in the web browser and the web state server
88—web server that serves out the special two-frame web page to the follower for co-browsing
90—special two-frame web page on the server that is served out to the follower that contains two frame pages for co-browsing
92—network connection between the web server which has the special two-frame web page and the follower's computer
94—leader toolbar code that works with the leader toolbar dynamically linked library
96—leader toolbar dynamically linked library
98—browser web page within the leader's internet web browser
100—leader internet browser engine within the internet web browser
102—network connection between the leader's web browser and the web state server
104—network connection between the leader web browser and the web page content server
106—follower toolbar code that works with the follower toolbar dynamically linked library
108—follower toolbar dynamically linked library
110—follower web page within the follower's internet web browser
112—follower internet browser engine within the internet web browser
114—network connection between the follower's web browser and the web state server
116—network connection between the follower web browser and the web page content server
118—follower bottom frame of special web page which contains the script code that enables the follower to do the account login, to get the leader's URL data from the web state server to the follower's bottom frame of the special web page and to periodically get the most recent URL data from the web state server
120—special two-frame web page that contains the two frames for co-browsing
122—top frame of the special web page where the follower views the co-browsing with the leaders
124—follower internet browser engine within the internet web browser
126—network connection between the follower's special web page in the web browser and the web state server
128—network connection between the follower's special web page in the browser and the web page content server

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The method or arrangement of connecting the parts listed below is well-known to those with ordinary skills in website computer programming. The leader browser toolbar and the follower browser toolbar software are constructed with ordinary software tools used in the development of toolbars for web browsers. The creation of the web state server is constructed by someone with ordinary web site programming skills. The creation of the follower special two-frame web page is doable by someone with ordinary web page development skills.

Operation:

There are two major subsystems to the system: The first subsystem goes from the leader's web browser 20, 56 to the web state information on the web state server 76 and the second subsystem goes from the web state information 76 on the web state server 72 to the follower's web browser with the follower toolbar 68, 36 or to the follower's web browser with the special two-frame web page 82, 44.

There are two approaches that can be used by the first subsystem. In the first approach the leader uses a toolbar application embedded in the leaders browser 10 to post the URL and query string data to the account 74 on the web state server 72 and store it in the web state data file 76 and in the second approach the leader uses a multi-frame programmed web page to post the URL and query string data to the account 74 on the web state server 72 and store it in the web state data file 76. The leader toolbar 10 approach is part of this patent while the leader programmed web page approach is based on prior art.

There are two approaches that can be used by the subsystem that gets the page data from the web state data file 76 in the account 74 on the web state server 76 to the followers who are co-browsing with the leaders. In the first approach the follower uses a follower toolbar application 28 embedded in the follower's browser 36, 68 to get the leader's URL page data from the web state data file 76 in the account 74 on the web state server 76 and in the second approach the follower uses a special two-frame web page 120, 52 get the leader's URL page data from the web state data file 76 in the account 74 on the web state server 76. Both the follower toolbar approach and the follower programmed web page approach are part of this patent.

The Operation of the Two Major Subsystems is as Follows:

1) Operation of the subsystem that posts the leader's URL and query string data to the account 74 on the web state server 72 and stores it in the web state data file 76:

The leader installs the leader toolbar 10 onto the computer 54 of the leader. This leader toolbar 10 consists of the leader toolbar dynamically linked library with it's associated files 96 and the leader toolbar code 94 that performs all of the co-browse functions. When the leader browser 20, 56 is run on the leader's computer 54, the browser loads and runs the internet browser engine 100, the leader toolbar dynamically linked library 96, the leader toolbar code 94 and the displayed web page in the leader browser which at browser startup is the default web page 98, 22. The leader browser toolbar is responsible for getting the page URL and query string information from the displayed web page 22, 98 and posting the information to a location on the web state server 72 where the followers can find the information and use it.

By installing the leader toolbar 10 into the leader browser 20, 56 a dynamically linked library file and it's associated support files 96 and the leader toolbar code with the co-browsing code algorithms 94 have been added to the leader's computer 54.

The first step before co-browsing is to log into the proper account 74 on the web state server 72. To do this the leader pushes the AccountLogin button 16 and via the network connection 64, 102 opens up a login window within the web browser 22, 98 that enables the leader to log into the account 74 located on the state web server 72. By logging into the account 74 the leader toolbar 10 has now been directed to post the state information to the account 74 which writes the URL and query string state data to an XML file on disk 76. The followers need to be informed as to the which account the leader has logged in to and to which they will also need to log in to so as to get the leader's page URL, frame URLs and any query string information.

Internally to the leader toolbar 10 what is occurring during login is that the leader toolbar code 94 that is running with the leader toolbar dynamically linked library 96 is responsible for the display and function of the AccountLogin button 16. The leader toolbar application detects the pushing of the AccountLogin button 16 and does an HTTP or HTTPS request of the account login page located on the state web server 72. The account login page is then displayed in the leader's browser window 22, 98 so that the leader can login to the account 74.

Once logged in to the account 74 the leader can begin to co-browse. To co-browse the leader first enters in the URL of the desired content web page 62 on the web content server 60 into the address bar 12 of the leader's browser 20, 56 and hits Enter. This sends a page request from the browser 20, 56 over the network connection 58, 104 to the web content server 60.

At this point the web content server 60 gets the web page content 62 and sends it back over the network connection 58, 104 to the leader's computer 54 and is loaded into the leader's browser 20, 56 and displayed in the browser window 22, 98.

The web page displayed in the window 22, 98 can be completely described by enumerating all of it's object elements via the document object model. The most important of fhese for co-browsing is the URL of the page with any associated query string and the URLs of the frames within the web page. In addition, other objects such as the URLs of photos 26 and hyperlinks 24 and all the other objects contained in the web page and associated with the document object model can potentially be extracted and used for other embodiments of co-browsing.

To initiate co-browsing the leader pushes the POSTpageDataToStateServer button 14. This button initiates the routine in the leader toolbar code 94 that obtains from the web page displayed in the leader's browser 22, 98 the URL of the page with any associated query strings and the URLs of the frames within the web page and posts this information over the network connection 64, 102 to the account 74 on the web state server 72. The account 74 is running a program that takes the posted URL and query string information and writes it into an XML file within the account 76. The routine in the leader toolbar code 94 is Windows application code that is compatible with the leader toolbar dynamically linked library 96 and which can extract any and all information needed from the displayed web page 22, 98 by navigating the document object model with the web page.

The leader toolbar code 94 underlying the POSTpageDataToStateServer can be run in either a Manual mode or Automatic mode by pushing the Manual/Automatic button 18 on the toolbar. When the leader toolbar POSTpageDataToStateServer button 14 is run in manual mode the leader must push this button each time the leader changes the displayed web page 22, 98 that the leader wants the followers to co-browse to. The advantage of manual mode is that the leader can freely browse between the times when the leader pushes the POSTpageDataToStateServer button 14 and therefore minimize unnecessary co-browsing by the followers. When the leader toolbar POSTpageDataToStateServer button 14 is run in automatic mode the leader toolbar code periodically pushes the POSTpageDataToStateServer button 14 automatically. The advantage of automatic mode is that the leader will not forget to co-browse the followers.

2) Operation of the follower toolbar version of the subsystem that gets the leader's URL and query string data from the web state data file 76 in the account 74 on the web state server 72 and updates the follower's web browser window 38, 110:

The follower installs the follower toolbar 28 onto the computer 66 of the follower. This follower toolbar 28 consists of the follower toolbar dynamically linked. library with it's associated files 108 and the follower toolbar code 106 that performs all of the co-browse functions. When the the follower browser 36, 68 is run on the follower's computer 66, the browser loads and runs the internet browser engine 112, the follower toolbar dynamically linked library 108, the follower toolbar code 106 and the displayed web page in the follower browser which at browser startup is the default web page 38, 110. The follower browser toolbar is responsible for doing a get of the leader page URL, the frame URLs and query string information from the appropriate file 76 from within the account 74 on the web state server 72 and update the displayed web page 38, 110 within the follower's browser 36, 68.

By installing the follower toolbar 28 into the follower browser 36, 68 a dynamically linked library file and it's associated support files 108 and the follower toolbar code with the co-browsing code algorithms 106 have been added to the follower's computer 66.

The first step before co-browsing is to log into the proper account 74 on the web state server 72. To do this the follower pushes the AccountLogin button 34 and via the network connection 78, 114 opens up a login window within the web browser 36, 68 that enables the follower to log into the account 74 located on the state web server 72. By logging into the account 74 the follower toolbar 28 has now been directed to get the state information from the account 74 which reads the URL and query string state data from the XML file on disk 76. The followers need to always be logged into the same account the leader has logged in to so as to get the leader's page URL, frame URLs and any query string information.

Internally to the follower toolbar 28 what is occuring during login is that the follower toolbar code 106 that is running with the follower toolbar dynamically linked library 108 is responsible for the display and function of the AccountLogin button 34. The follower toolbar application detects the pushing of the AccountLogin button 34 and does an HTTP or HTTPS request of the account login page located on the state web server 72. The account login page is then displayed in the follower—s browser window 38, 110 so that the follower can login to the account 74.

Once logged in to the account 74 the follower can begin to co-browse. To initiate the co-browsing session the follower pushes the GETpageDataFromStateServer button 32. This button initiates the routine in the follower toolbar code 106 that on a periodic basis automatically gets via an HTTP or HTTPS request from the web state server 72 the XML file data found on the file 76 in the account 74. This XML file contains the information about the page displayed in the leader's browser 22, 98. In particular, the follower toolbar code 106 gets the XML file and extracts the URL of the leader's page with any associated query strings and the URLs of the frames within the leader's web page. The routine in the follower toolbar code 106 is a Windows application code routine that is compatible with the follower toolbar dynamically linked library 108 and which updates the displayed web page in the follower browser 38, 100. The update request by the toolbar code instructs the follower's internet web browser engine 112 to send a page request from the browser 36, 68 over the network connection 70, 116 to the web content server 60. At this point the web content server 60 gets the web page content that matches that of the leader 62 and sends it back over the network connection 70, 116 to the follower's computer 66 and is loaded into the follower's browser 36, 68 and displayed in the browser window 38, 110. In addition the address bar 30 in the follower's browser 36, 68 is updated to match the URL of the leader.

Operation of the special web page version of the subsystem that gets the leader's URL and query string data from the web state data file 76 in the account 74 on the web state server 72 and updates the follower's upper frame in the special web page in the follower's web browser window 52, 120:

The follower enters into the address bar 40 of the follower's browser 44, 82 the URL of the location of the special two-frame web page 90 located on the server 88. When the follower hits Enter an HTTP or HTTPS request is made over the network connection 92 to the web server 88 to get the special two-frame web page 90. The requested special web page is returned over the network connection 92 to the follower's computer 80 and displayed in the follower's browser window 52, 120.

The special two-frame web page 120, 52 consists of the follower bottom frame of the special web page 50, 118 and the top frame of the special web page 42, 122. The bottom frame 50, 118 contains consists of the follower code that performs all of the co-browse functions. This follower code and all of the bottom frame 50, 118 and top frame 42, 122 is runs within the internet web browser engine 124. The follower code inside the bottom frame 50, 118 is responsible for doing a get of the leader page URL, the frame URLs and query string information from the appropriate file 76 from within the account 74 on the web state server 72 and update the displayed web page within the follower's top frame of the special web page 42, 122.

The first step before co-browsing is to log into the proper account 74 on the web state server 72. To do this the follower pushes the AccountLogin button 48 and via the network connection 86, 126 opens up a login window within the top frame of the web browser 42, 122 that enables the follower to log into the account 74 located on the state web server 72. By logging into the account 74 the bottom frame of the special web page 50, 118 has now been directed to get the state information from the account 74 which reads the URL and query string state data from the XML file on disk 76. The followers need to always be logged into the same account the leader has logged in to so as to get the leader's page URL, frame URLs and any query string information.

Internally to the follower bottom frame of the special web page 50, 118 what is occurring during login is that the follower bottom frame of the special web page that is running is responsible for the display and function of the AccountLogin button 48. The follower toolbar application detects the pushing of the AccountLogin button 48 and does an HTTP or HTTPS request of the account login page located on the state web server 72. The account login page is then displayed in the follower's top frame of the special web page 42, 122 so that the follower can login to the account 74.

Once logged in to the account 74 the follower can begin to co-browse. To initiate the co-browse session the follower pushes the GETpageDataFromStateServer button 46. This button initiates the code routine in the follower bottom frame of the special web page 50, 118 that on a periodic basis automatically gets via an HTTP or HTTPS request from the web state server 72 the XML file data found on the file 76 in the account 74. This XML file contains the information about the page displayed in the leader's browser 22, 98. In particular, the code routine in the follower bottom frame of the special web page 50, 118 gets the XML file and extracts the URL of the leader's page with any associated query strings and the URLs of the frames within the leader's web page. The code routine in the bottom frame of the special web page 50, 118 is a Javascript routine which updates the displayed web page in the follower's top frame of the special web page 42, 122. The update request by the toolbar code instructs the follower's internet web browser engine 124 to send a page request from the browser 44, 82 over the network connection 84, 128 to the web content server 60. At this point the web content server 60 gets the web page content that matches that of the leader 62 and sends it back over the network connection 84, 128 to the follower's computer 80 and is loaded into the follower's browser 44, 82 and displayed in the top frame of the browser window 44, 122.

Alternative Embodiments:

Many other variations on the invention are possible:

Rather than a client-server approach as describe above it is possible to design a peer-to-peer implementation whereby leader URL state information can be obtained directly by the followers from the leaders embedded toolbar application. In this design the toolbar would be interacting with a peer-to-peer servant installed on the leader's or follower's computer that supports, for example, the Gnutella Protocol. The leader's toolbar would take the browser's URL data and update a local XML file with this data. The locally-installed peer-to-peer servant would make this file sharable with other peer-to-peer servants on the Gnutella Network that could periodically obtain this XML file. Then a follower browser toolbar would read the XML file and update the follower's web browser window.

Rather than using the HTTP or HTTPS protocol other network protocols can be used to send and receive co-browse state data between the leader's toolbar and the follower's toolbar.

Rather than displaying entire web pages, partial web pages can be displayed such as photos, hyperlinks and other objects that have URLs and query strings obtainable from the leader's displayed web page by using the ability of Windows application code to obtain information about the objects present inside of the leader's web page.

In the above-described design the URL of the content displayed in the leader's web browser used the HTTP or HTTPS protocols to obtain content from a web server, however, this system also works with other URL types such as file:///. Hence it is possible to co-browse with individuals on separate computers that have the same files located in the same location on the respective leader and follower computers.

Since only URLs are passed from the leader to the follower it is possible to use other delivery mechanisms such as radio to transmit the URLs of the leader that the followers should co-browse to provided there were mechanisms in place to encode the URL co-browse information into the transmitted radio waves and decode the URL co-browse information at the receiving side of the radio waves.

Another co-browse delivery mechanism for the leader's URL data is through instant messaging chat windows. A co-browse leader can have a web browser toolbar installed that reads the leader's web page URL data and passes it to an instant messaging chat client. The URL data is passed to the client in a pre-specified co-browse format that indicates that it is co-browse URL data. Once the URL data is inserted into the instant messaging chat client from the toolbar the chat message can be automatically passed to the chat server and ultimately to the followers that the leader is instant-message-chatting with. Once the URL data has been transmitted to the follower's chat client a follower web browser toolbar can periodically read the data in the chat window that matches the pre-specified co-browse format. The URL data is extracted from that format by the toolbar and the follower's web browser window is automatically updated accordingly.

Another co-browse delivery mechanism for the leader's URL data is through email clients. A co-browse leader can have a web browser toolbar installed that reads the leader's web page URL data and passes it to an email client with pre-specified follower email destination addresses. The URL data is passed to the email client as an email message in a pre-specified co-browse format that indicates that it is co-browse URL data. Once the URL data is inserted into the email client as an email message from the toolbar the email message can be automatically passed to the email server and ultimately to the followers that the leader is has pre-specified as the email destination addresses. Once the URL data has been transmitted to the follower

s email client a follower web browser toolbar can periodically read the email data from the email client that matches the pre-specified co-browse format. The URL data is extracted from that format by the toolbar and the follower

s web browser window is automatically updated accordingly.

Since a very low data rate is possible it is possible to use this methodology to do co-browsing on cell phones, wireless or wired personal digital assistants and other small devices.

The storage of the URL state data can take many forms. In this implementation XML files were used to store the leader

s web page state data. Alternatives include storing this data in a data base or in computer memory.

Browsers can launch any content which can not be displayed in the browser. This system can launch and work with many types of tiles such as executable files, audio files, video files, pdf files and document files.

The special two-frame web page can be designed to use many files. For example the Javascript of the bottom frame could be written into a separate file. Many alternative embodiments of the basis multi-frame design are possible.

The toolbar code can be designed to use other programming languages such as VBscript, C, etc. Also the toolbar code dynamically linked library could be compiled as one executable without the use of an external Windows application code that controls the behavior of the dynamically linked library. Web browsers such as Microsoft Internet Explorer support the addition of functionality to the web browser through the use of toolbars, plug-ins and ActiveX objects. The main requirement is that the embodiment of the resultant toolbar be able to get the web page information associated with the document object model such as the page URL and any associated query strings and the frame URLs from the leader's web page so that this information can be gotten to the followers in some manner.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. A system for interactive internet co-browsing which comprises:
means for logging into an account on a web state server that saves the URL data to a specific location;
means for obtaining-page-URL-data from a co-browsing leader's web browser;
means for encoding the URL data into standard format data;
means for transmitting the said standard format data to the said web state server;
means for saving the said standard format data on the said web state server;
means for obtaining periodically the said standard format data from the said web state server without overloading the processes on said web state server;
means for de-encoding the standard format data into URL data; and
means for updating the co-browse follower's web browser to correspond to said URL data.

2. A method for interactive internet co-browsing which comprises: obtaining the URL data of a co-browsing leader's web browser page by inspecting the URL values of the frame objects by traversing the document object of the web browser page;
encoding the URL data into a standard format data;
transmitting the URL data in the standard format data to a web state server that writes the URL data to a specific location on the web state server;
reading periodically by co-browse followers the standard format data from the web state server;
de-encoding the standard format data into URL data; and updating the followers displayed web page to display the said URL data.

3. The method of claim 2 further comprising the step of co-browse leaders and followers logging into an account that corresponds to the said specific location of the standard format data on the web state server.
